(19) United States
(12) Patent Application Publication
(10) Pub. No.: US 2011/0146294 A1
(43) Pub. Date: Jun. 23, 2011

(54) AIRPLANE ENGINE DEFLECTOR SYSTEMS

(76) Inventor: Rubin Townsend, Tempe, AZ (US)

(21) Appl. No.: 12/878,096

(22) Filed: Sep. 9, 2010

Related U.S. Application Data
(60) Provisional application No. 61/288,917, filed on Dec. 22, 2009.

(51) Int. Cl. F02C 7/00; F02G 3/00

(52) U.S. Cl. 60/779; 60/39.092

(57) ABSTRACT

A protective deflector for airplane engines system is disclosed herein comprising a turbine-covering screen assembly which may be installed to an airplane engine turbine housing by a securable fastening device. The turbine-covering screen assembly comprises a protruded bell-shaped extrusion member having a plurality of apertures which may serve to prevent birds, objects and other debris from penetrating a turbine housing air-intake opening thereby protecting an airplane engine from interference during flight. The turbine-covering screen assembly does not appreciably affect the performance of the turbine engine it serves to protect.

### CROSS-REFERENCE TO RELATED APPLICATION

The present application is related to and claims priority from prior provisional application Ser. No. 61/288,917, filed Dec. 22, 2009 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

1. Field of the Invention

The present invention relates generally to the field of deflectors and more specifically relates to protective deflectors for airplane engine turbines.

2. Description of the Related Art

Airplanes are used in modern society to transport individuals. Every year, hundreds of airplanes are involved in accidents caused by collisions with birds. A risk of engine damage exists when a bird's flight path intersects with that of an airplane. The bird may get pulled into the engine turbine from the tremendous force of the air being sucked into the turbines which may cause serious damage to the engine potentially resulting in an airplane crash. Airplane crashes are typically devastating to human life. Further, these crashes are tremendously expensive due to the loss of equipment and because they usually result in subsequent investigations and law suits. Birds that fly into engines are an on-going serious problem that plagues the aviation industry.

Current safety precautionary measures taken to prevent bird collisions may consist of ‘on-the-ground’ techniques such as manually shooing away birds, installing landscaping designed to entice flocks away from airstrips and using strobe lights to deter them. These practices help in reducing collisions, but due to the enormous downside potential and dire consequences, a better solution is needed that can reliably prevent birds from coming into contact with airplane engines.

Various attempts have been made to solve the above-mentioned problems such as those found in U.S. Pat. Nos. 4,833,879, 2,931,460, 6,089,824, 4,077,739, 6,138,950, 3,426,981, 3,302,395, and 6,598,384. This prior art is representative of protective deflectors for airplane engines. None of the above inventions and patents, taken either singly or in combination, is seen to describe the invention as claimed.

Ideally, an airplane engine deflector should require minimal maintenance, not dramatically impede airflow through the turbine(s) and yet, operate reliably and be manufactured at a modest expense. Thus, a need exists for a reliable airplane engine deflector system to deflect birds, objects, and other debris thereby preventing damage from occurring to airplane engines and to avoid the above-mentioned problems.

### BRIEF SUMMARY OF THE INVENTION

In view of the foregoing disadvantages inherent in the known deflector art, the present invention provides a novel airplane engine deflector system. The general purpose of the present invention, which will be described subsequently in greater detail, is to provide a replaceable protective screen deflector securable to an airplane engine housing opening to deflect birds, objects, and other debris from penetrating an engine turbine housing air-intake opening and interfering with an airplane engine.

In view of the foregoing disadvantages inherent in the known airplane engine protection art, the present invention holds significant improvements and serves as an airplane engine deflector system. In the field of aviation, engine interference during flight may result in an emergency landing or even worse an airplane crash. Therefore, the importance of securely and sturdily protecting an airplane engine during flight is critical in airline safety.

An airplane engine deflector system is disclosed herein comprising: a turbine-covering screen assembly and a securable fastening device wherein the turbine-covering screen assembly includes an (inwardly or outwardly) protruded bell-shaped extrusion member, a mounting plate, and a base ring. At least one fastening device may be used to removably attach the assembled turbine-covering screen assembly to at least one airplane engine turbine housing air-intake opening to prevent birds and debris from passing through the airplane engine turbine housing air-intake opening such that an airplane engine is thereby protected.

The turbine-covering screen assembly within the present embodiment is fabricated of a strong, lightweight, pressure-resistant metal. The bell-shaped extrusion member forms a deflector screen having a plurality of apertures. The apertures permit air to freely pass while deflecting birds and other debris. In one embodiment of the present invention, the turbine-covering screen assembly may comprise a convex-shaped deflection screen. In another embodiment of the present invention, the turbine-covering screen assembly may comprise a concave-shaped deflection screen.

The airplane engine deflector system may be detachably installed to an airplane such that the screen assembly may be readily detached from the airplane engine turbine housing of the airplane for maintenance and part replacement. As a result, individual components of the turbine-covering screen assembly may be regularly tested, maintained, and replaced when needed to provide a higher safety standard in protecting an airplane engine during flight. Further, the airplane engine deflector system may be available in different shapes and sizes to fit a variety of airplane engine turbine housing air-intake openings of different aircrafts.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, airplane engine deflector system, constructed and operative according to the teachings of the present invention.

FIG. 1 shows a perspective view illustrating an airplane engine deflector system in an in-use condition as secured to an airplane engine turbine housing air-intake opening according to an embodiment of the present invention.

FIG. 2 is a perspective view illustrating the airplane engine deflector protective screen assembly according to an embodiment of the present invention of FIG. 1.

FIG. 3 shows a perspective view illustrating the airplane engine deflector system in an in-use condition as secured to an airplane engine turbine housing air-intake opening according to an alternative embodiment of the present invention.

FIG. 4 shows a perspective view illustrating the airplane engine deflector system in an in-use condition as secured to an airplane engine turbine housing air-intake opening according to an embodiment of the present invention of FIG. 3.

FIG. 5 is an airplane engine deflector system kit according to an embodiment of the present invention of FIG. 1.

FIG. 6 is a flowchart illustrating a preferred method of use for the airplane engine deflector system according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to an airplane engine deflector system and more particularly to an airplane engine deflector system to deflect birds, objects, and other debris from penetrating an engine turbine housing and interfering with an airplane engine. Every year, hundreds of airplanes are involved in accidents caused by collisions with birds and other flying objects. A risk of engine damage exists when a bird's flight path intersects with that of an airplane. The bird or object may get pulled into the engine turbine from the tremendous force of the air being ‘sucked’ inwardly and may lead to serious damage to the engine. Such damage may result in a catastrophic airplane crash. This is a serious problem that plagues the aviation industry. The safety of an airplane engine during flight is of utmost concern and requires the ultimate standard of care, as modern technology permits, in protecting the integrity and stability of the aircraft and the lives of the passengers onboard. Further, it is of concern that birds and other wildlife are protected from harm. The present invention serves to solve these and other related problems as disclosed herein.

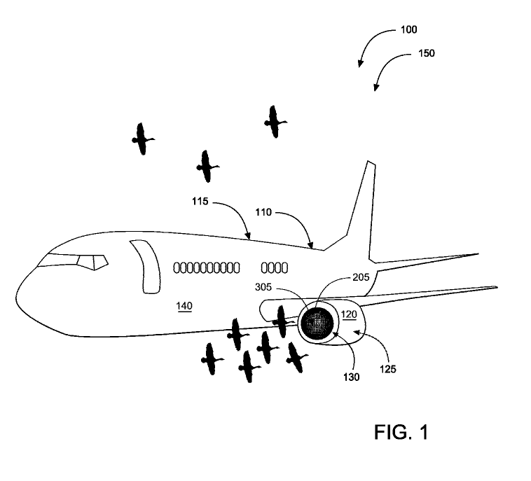

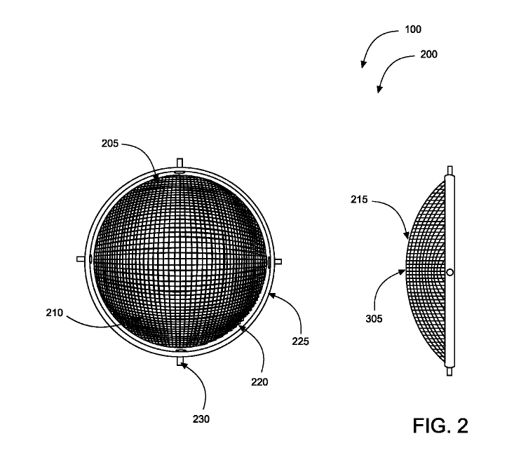

Referring to the drawings by numerals of reference there is shown in FIG. 1 airplane engine deflector system 100 in an in-use condition 150 installed to engine turbine housing 120 of airplane 110. Airplane engine deflector system 100 may generally comprise deflector screen 205 that may be securably installed to engine turbine housing 120 of airplane 110 to deflect birds and other substantial debris from entering into and interfering with engine 125. Turbine-covering screen assembly 200 may be manufactured of high-grade alloyed metals or other suitable material tested to withstand air pressure present during operation. Dotted airflow lines are shown in FIG. 2 to illustrate relative air flow direction in-use. It should be noted that convex-shaped 305 and concave-shaped 310 face the airflow in inverse relationships, as alluded to subsequently within this disclosure.

In an embodiment of the present invention as shown in FIG. 1, deflector screen 205 protrudes outwardly (at least herein embodying concave displacement of deflector screen 205) from engine turbine housing 120 and serves to effectively prevent birds, objects, and other such flying or airborne debris from penetrating/entering turbine housing air-intake opening 130, yet allowing air to freely pass through engine 125 without creating an unsuitable turbulence. Engine 125 is thereby protected from interference by birds and debris using the present invention. Airplane engine deflector system 100 comprises turbine-covering screen assembly 200 which is detachably installable to engine turbine housing 120 by at least one securing means, herein embodied as securable fastening device 230.

Referring now to FIG. 2, a perspective view illustrating turbine-covering screen assembly 200 as used on aircraft 115 or airplane 110 according to an embodiment of the present invention of FIG. 1. Turbine-covering screen assembly 200 may comprise deflector screen 205, bell-shaped extrusion member 215, mounting plate 220, base ring 225, and securable fastening device 230. Turbine-covering screen assembly 200 and components within are preferably fabricated of at least one strong, lightweight, pressure-resistant metal or alloyed metal design to withstand air-pressure and impacts while stationary and when in flight. In an embodiment of the present invention, deflector screen 205 and bell-shaped extrusion member 215 jointly combine to create an embodiment of turbine-covering screen assembly 200—convex-shaped 305 deflector screen 205 having a plurality of filter apertures 210. Deflector screen 205 and bell-shaped extrusion member 215 may be frictionally secured to mounting plate 220 and held firmly in place by base ring 225 (or in other embodiments, by other suitable means). Convex-shaped 305 deflector screen 205 as shown in FIGS. 1 and 2 protrudes outwardly creating a barrier, thereby permitting objects struck by deflector screen 205 to ricochet away from engine turbine housing 120 while airplane 110 is in flight.

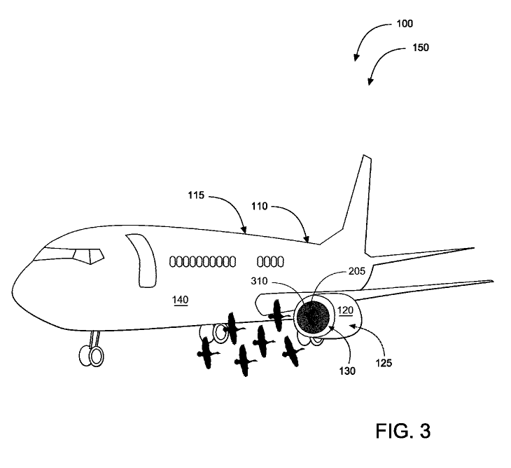

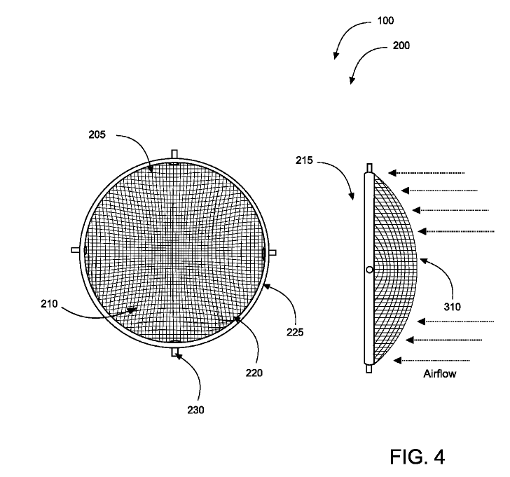

Referring now to FIGS. 3 and 4, illustrating an alternative embodiment of airplane engine deflector system 100 in an in-use condition 150 installed (removably coupled) to engine turbine housing 120 of airplane 110. In an embodiment of the present invention as seen in FIG. 3, deflector screen 205 protrudes inwardly into engine turbine housing 120 (at least herein embodying concave-shaped 310) and also serves to prevent birds, objects, and other such airborne debris from penetrating turbine housing air-intake opening 130 while allowing air to still freely pass through and meet intake and exhaust requirements of engine 125. In the present embodiment, deflector screen 205 and bell-shaped extrusion member 215 jointly combine to create concave-shaped 310 deflector screen 205 having a plurality of filter apertures 210. Deflector screen 205 and bell-shaped extrusion member 215 is preferably frictionally secured to mounting plate 220 and held firmly in place by base ring 225. Convex-shaped 310 deflector screen 205 as shown in FIGS. 3 and 4 protruding inwardly thereby providing a suitable means to deflect birds, debris, and other objects struck/impacted against deflector screen 205 to be knocked away from engine turbine housing 120 while airplane 110 is in flight. In this way the present invention provides an efficient and effective manual barrier to prevent impact damages from occurring. The rigid, air-pressure resistant metal of deflector screen 205 and filter apertures 210 provide for a free flow of air to engine 125 while deflecting harmful objects.

As best seen in FIGS. 1 and 3, mounting plate 220 is detachably installable to engine turbine housing 120 of airplane 110. Deflector screen 205 is preferably coupled to the perimeter of turbine housing air-intake opening 130 using securable fastening device 230. Any suitable fastening means may be used that is tested and approved to withstand air-pressure/force and resistance during flight.

Much like performing any other maintenance tasks on airplane 110, it is highly important that airplane engine deflector system 100 be properly approved, maintained and tested. When installing deflector screen 205 to engine turbine housing 120 of airplane 110 or aircraft 115, mounting plate 220 must be in a suitably secured coupled relationship to turbine housing air-intake opening 130 using securable fastening device 230 for safe and proper use.

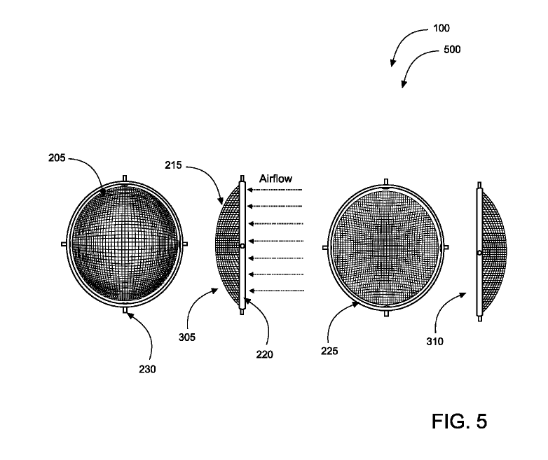

Referring now to FIG. 5, airplane engine deflector system 100 may be manufactured and/or sold as kit 500 comprising the following parts: at least one turbine-covering screen assembly 200 (convex-shaped 305 and/or concave-shaped 310); comprising at least one deflector screen 205 having filter apertures 210; at least one bell-shaped extrusion member 215; at least one mounting plate 220; at least one base ring 225; at least one securable fastening device 230; and at least one set of user/maintenance instructions. Airplane engine deflector system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

It should be appreciated that airplane engine deflector system 100 may be used to protect engine turbine housing 120 of various types of commonly flown aircrafts 115. In an exemplary embodiment, airplane engine deflector system 100 is designed to protect engine 125 of a commercial airplane 110. Airplane engine deflector system 100 may also be manufactured in a variety of diameter sizes to fit turbine housing air-intake opening 130 of engine turbine housings 120 of different dimensions.

Airplane 110 mechanics and other authorized personnel may easily detach deflector screen 205 to complete routine engine maintenance and replace deflector screen 205 as needed. Air travel safety may be greatly improved if this device were installed in airplane 110 engine turbines to prevent accidents caused from collisions with birds or other large debris.

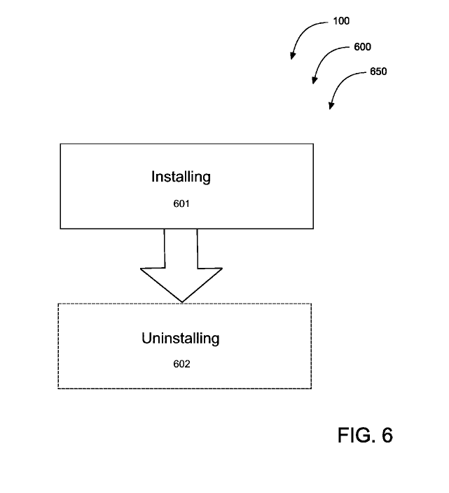

Referring now to FIG. 6, illustrating flowchart 650 of method of use 600 of airplane engine deflector system 100. According to a preferred method of use 600, airplane engine deflector system 100 comprises step one 601 installing turbine-covering screen assembly 200 in a coupled relationship to perimeter of airplane engine turbine housing air-intake opening 130 using securable fastening device 230 to prevent impact damage to engine 125, and; step two 602 uninstalling turbine-covering screen assembly 200 from airplane engine turbine housing air-intake opening 130 by releasing securable fastening device 230. Various steps of maintenance may also be included in the user/maintenance instruction manual.

It should be noted that step two 602 is an optional step and may not be implemented in all cases. Optional step(s) of method 600 are illustrated using dotted lines in FIG. 6 so as to distinguish them from the other steps of method of use 600. It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An airplane engine deflector system comprising;
a turbine-covering screen assembly;
a securable fastening device;
wherein said turbine-covering screen assembly includes a protruded bell-shaped extrusion member, a mounting plate, and a base ring;
wherein said securable fastening device is used to removably attach said turbine-covering screen assembly to at least one airplane engine turbine housing air-intake opening; and
wherein said airplane engine deflector serves to prevent birds and debris from passing through said airplane engine turbine housing air-intake opening such that an airplane engine turbine is thereby protected.

2. The airplane engine deflector system of claim 1, wherein said turbine-covering screen assembly is fabricated of at least one strong, lightweight, pressure-resistant metal.

3. The airplane engine deflector system of claim 1, wherein said protruded bell-shaped extrusion member has a plurality of filter apertures preventing birds and objects from entering said airplane engine turbine housing air-intake opening while permitting air to freely pass therethrough.

4. The airplane engine deflector system of claim 3, wherein said protruded bell-shaped extrusion member is convex, protruding outwardly from said airplane engine turbine housing air-intake.

5. The airplane engine deflector system of claim 1, wherein said turbine-covering screen assembly is removably attachable to an outer surface of said airplane engine turbine housing air-intake opening for replacement and maintenance.

6. The airplane engine deflector system of claim 1, wherein said turbine-covering screen assembly is available in different sizes and dimensions to securely fit airplane engine turbine housing air-intake openings of different aircrafts.

7. The airplane engine deflector system of claim 1, wherein said protruded bell-shaped extrusion member, said mounting plate, said base ring, and said securable fastening device comprise a kit.

8. An airplane engine deflector system comprising;
a turbine-covering screen assembly;
a securable fastening device;
wherein said turbine-covering screen assembly includes an inward bell-shaped extrusion member; a mounting plate; and a base ring;
wherein said securable fastening device is used to removably attach said turbine-covering screen assembly to at least one airplane engine turbine housing air-intake opening; and
wherein said airplane engine deflector serves to prevent birds and debris from passing through said airplane engine turbine housing air-intake opening such that an airplane engine turbine is thereby protected.

9. The airplane engine deflector system of claim 8, wherein said turbine-covering screen assembly is fabricated of at least one strong, lightweight, pressure-resistant metal suitable for in-flight travel.

10. The airplane engine deflector system of claim 8, wherein said inward bell-shaped extrusion member has a plurality of filter apertures preventing birds and objects from entering said airplane engine turbine housing air-intake opening while permitting air to freely pass therethrough.

11. The airplane engine deflector system of claim 10, wherein inward bell-shaped extrusion member is concave protruding inwardly on said airplane engine turbine housing air-intake opening.

12. The airplane engine deflector system of claim 8, wherein said turbine-covering screen assembly is removably attachable to an outer surface of said airplane engine turbine housing air-intake opening for replacement and maintenance.

13. The airplane engine deflector system of claim 8, wherein said turbine-covering screen assembly is available in different sizes and dimensions to securely fit airplane engine turbine housing air-intake openings of different aircrafts.

14. The airplane engine deflector system of claim 8, wherein said inward bell-shaped extrusion member, said mounting plate, said base ring, and said securable fastening device comprise a kit.

15. An airplane engine deflector system comprising:
at least one turbine-covering screen assembly fabricated of a strong, lightweight, pressure-resistant metal or composite comprising a protruded bell-shaped extrusion member having a plurality of filter apertures, a deflector screen, a mounting plate, and a base ring;
at least one a securable fastening device;
wherein said deflector screen is either convex-shaped or concave-shaped;
wherein said fastening device is used to removably attach said turbine-covering screen assembly to at least one airplane engine turbine housing air-intake opening; and
wherein said airplane engine deflector serves to prevent birds and debris from passing through said airplane engine turbine housing air-intake opening such that an airplane engine turbine is thereby protected.

16. A method of using an airplane engine deflector system comprising the steps of:
installing a turbine-covering screen assembly in a coupled relationship to an airplane engine turbine housing air-intake opening; and
flying an airplane using said airplane engine deflector system to prevent birds and debris from entering an airplane engine.

17. The method of using an airplane engine deflector system of claim 16 further comprising the step of:
uninstalling said turbine-covering screen assembly from said airplane engine turbine housing air-intake opening to perform a maintenance service on said airplane engine.
